(19) United States
(12) Patent Application Publication
(10) Pub. No.: US 2012/0203148 A1
(43) Pub. Date: Aug. 9, 2012

(54) THERAPEUTIC AUDIO PULSE DELIVERY SYSTEM AND PROCESS

(76) Inventor: John Underwood, Sarnia (CA)

(21) Appl. No.: 13/235,034

(22) Filed: Sep. 16, 2011

Related U.S. Application Data
(63) Continuation-in-part of application No. 13/034,288, filed on Feb. 24, 2011.
Application No. 13/034,288 is a continuation-in-part of application No. 13/022,732, filed on Feb. 8, 2011.

(51) Int. Cl. A61H 1/00

(52) U.S. Cl. 601/47

(57) ABSTRACT

A system and process including a transponder and a hand-held transducer having a pulse delivery assembly and a sound pressure wave generating device driven by an electronics package. The electronics package is capable of outputting prerecorded programs, to the sound pressure wave generating device, upon receiving an instruction from the transponder. The electronics package responds to instructions by retrieving a labeled and stored prerecorded audio program and driving the sound pressure wave generating device. The sound pressure wave generating device is mechanically linked to a pulse delivery assembly having a hammer pad with attached permanent magnets. The pulse delivery assembly vibrates the hammer pad, which administers therapeutic patterned percussive pulses and a patterned fluctuating magnetic field through direct contact on the skin of a subject, according to the prerecorded program. Upon being disposed proximate to the electronics package, the transponder is configured to automatically establish communication and provide the instruction.

### CROSS-REFERENCE TO RELATED APPLICATION

This Continuation-In-Part Patent Application claims the benefit of co-pending U.S. Non-Provisional patent application Ser. No. 13/034,288, filed Feb. 24, 2011, and also claims benefit to co-pending U.S. Non-Provisional patent application Ser. No. 13/022,732, filed Feb. 8, 2011, which are all incorporated herein in their entireties.

### FIELD OF THE INVENTION

The present disclosure generally relates to an apparatus and method for delivering therapeutic sound wave pulses to the skin of a subject. More particularly, the present disclosure relates to a system and process incorporating a remote transponder communicating with a transducer for initiating the delivery of patterned sound wave pulses to the skin of a subject by direct percussion and fluctuating magnetic field.

### BACKGROUND OF THE INVENTION

The application of therapeutic sound waves to the skin of a subject is a process within the field of alternative medicine. The process is practiced by generating a pulse wave, from an acoustic loudspeaker, and delivering the series of pulses to the skin of a subject, by direct percussion or by placing the wave generating mechanism in close proximity to the skin. In either case, the pulses are delivered to the skin at a frequency approximately equal to an output frequency of the loudspeaker. The field of alternative medicine also includes the practice of applying a magnetic field to the skin of a subject. One aspect of the practice includes the placement of a static permanent magnet proximate to the skin. This practice has been studied but is generally believed to have questionable efficacy; however, the practice of applying a fluctuating magnetic field to the skin has also been studied and appears to hold more promise in the possible treatment of a wide variety of ailments.

Permanent magnets have been incorporated into therapeutic sound wave devices to achieve the application of percussive pulses with fluctuating magnetic fields, in a single device. The single devices with multiple capabilities allow for sound wave and magnet treatments to be administered simply and conveniently. While the effectiveness of the treatments is not well settled, the field is active and the devices are a valuable tool for testing and experimentation, in addition to the administration of treatment.

Conventional therapeutic sound wave devices require an applicator portion connected, by wire, to an electronic wave generator. The devices tend to be bulky and relatively expensive. In addition, the user must manually input information to the electronic wave generator to select the frequency and duration of pulses to be delivered by the system. Further, conventional devices are configured to allow for adjustment and control of the frequency of pulses but currently, there is no provision for patterns of pulses incorporating varying frequencies. The field of sound wave therapy has suggested that patterns of distinct sound tones administered in sequence may have therapeutic effect superior to a series of sound wave pulses at a single frequency. Research has developed particular sound tone sequence patterns determined to be effective in treating certain specific ailments.

There is a need for a remote transponder incorporated in a therapeutic sound wave system to provide for automatic information input. There is a need for a therapeutic sound wave system incorporating a compact transducer capable of communicating with a remote transponder to receive instruction for retrieving and delivering ailment specific patterned percussive pulses and a patterned fluctuating magnetic field.

### SUMMARY OF THE INVENTION

The present invention is directed to a system to provide a therapeutic pattern of pulses onto a skin of a patient for treatment of ailments. The system provides a set of instructions for generating ailment specific patterned percussive pulses and a patterned fluctuating magnetic field. The instructions can be distributed through prescriptions. The prescriptions defined a set of instructions respective to a diagnosed ailment. The instructions can be transferred to the patient using any electronically storage media. One exemplary embodiment utilizes as transmissive card for retaining and transferring the electronic instructive data to a transducer.

The present invention includes the set of instructions for generating a pattern of pulses, transfer the set of instructions to a transponder, and produce the pattern of pulses. The set of instructions are programmed into a passive transmissive card, utilizing technology that is similar to that utilized in Radio-frequency identification (RFID). The information stored with the instruction card is wirelessly communicated to the transponder using a reader. The reader is in signal communication with the transponder. The reader transmits a signal that excites an antenna within the instruction card. The excited antenna creates a current within a closed loop circuit included in the instruction card. The circuit encodes the programmed data into the current. The current continues to pass through the circuit, including the antenna. As the current passes through the antenna, the antenna broadcasts the embedded signal, which is received by the reader.

A first aspect of the present invention provides a therapeutic pulse generating system comprising:
an instruction card comprising a housing, an electronic memory device, a wireless transmitting circuit, and a set of instructions for producing a pattern of pulses;
a pulse instruction data receiving device comprising a wireless receiving circuit for receiving wireless pulse instruction data transmissions from the instruction card;
a transponder in signal communication with the pulse instruction data receiving device;
wherein the set of instructions for producing a pattern of pulses is directed towards therapeutic treatment of a patient by administering a therapeutic pattern of percussive pulses and a pattern of fluctuating magnetic fields onto a patient's skin.

A second aspect of the present invention incorporates a transponder, a transducer, an electronics package, and a power supply. The transducer includes a sound pressure wave generating device (such as a loudspeaker), a pulse delivery assembly, and a housing.

Another aspect integrates an electronics package being operably connected to the power supply and includes a signal transceiver, a microcomputer, an amplifier, and an audio signal output. The signal transceiver is operably connected to the microcomputer and is configured to initiate communication with the transponder, receive and process instruction, from the instruction generating means, and to deliver a command signal to the microcomputer. The microcomputer is operably connected to the amplifier, and is programmed and configured to receive the command signal and respond by retrieving and outputting one or more prerecorded audio programs to the amplifier, according to the command signal. The amplifier is provided with an operable connection to the sound pressure wave generating device for reproducing the audio programs. The amplifier may include digital to analog conversion circuitry for delivering an analog signal to the sound pressure wave generating device.

In yet another aspect, the pulse delivery assembly includes a hammer pad. The pulse delivery assembly is disposed proximate to the sound pressure wave generating device and includes an interface for transferring vibration produced by the sound pressure wave generating device to the hammer pad.

In yet another aspect, the housing defines an interior space and has an aperture communicating with the interior space. The sound pressure wave generating device and the pulse delivery assembly are disposed within the housing with the hammer pad at least partially protruding through the aperture.

In yet another aspect, the transponder may be directed to initiate communication with the signal transceiver, which issues a command signal to the microcomputer. The microcomputer responds by retrieving and outputting a signal to the amplifier driving the sound pressure wave generating device to produce a pressure wave in accordance with the programmed instructions. The generated sound pressure wave vibrates the hammer pad while the transducer is manually applied to the skin of a patient for administering therapeutic patterned pulses.

In yet another aspect, the hammer pad is designed for smooth sliding on the skin.

In yet another aspect, one or more permanent magnets may be mounted on the hammer pad for delivering a patterned fluctuating magnetic field, to the skin of the subject.

In yet another aspect, a transponder is provided having a communication link with a transducer in a therapeutic audio pulse delivery system for automatic information input.

In yet another aspect of the present invention, the therapeutic sound wave system incorporates a compact transducer capable of communicating with a remote transponder to receive instruction for retrieving and delivering ailment specific patterned percussive pulses and a patterned fluctuating magnetic field.

In another aspect, the instruction cards can be provided to a patient through a prescription process.

In another aspect, the instruction cards can be programmed by a Pharmacist using a database comprising an index of a series of instruction sets, each instruction set being directed towards one or more ailments. The database can be located on site, or accessible via either an Intranet or an Internet.

These and other aspects, features, and advantages of the present invention will become more readily apparent from the attached drawings and the detailed description of the preferred embodiments, which follow.

### BRIEF DESCRIPTION OF THE DRAWINGS

The invention will now be described, by way of example, with reference to the accompanying drawings, where like numerals denote like elements and in which:

FIG. 1 presents a perspective view of an exemplary embodiment of the transponder and transducer of the present invention;

FIG. 2 presents a perspective exploded assembly view of the transducer introduced in FIG. 1;

FIG. 3 presents a block diagram of an embodiment of the electronics package of the present invention;

FIG. 4 presents a perspective view of an electronics package, a sound pressure wave generating device, and a separator of an embodiment of the present invention;

FIG. 5 presents a perspective view of a suspension of an embodiment of the present invention;

FIG. 6 presents an exploded perspective view of a sound pressure wave generating device, an electronics package, and cover of an embodiment of the present invention;

FIG. 7 presents a perspective view of an embodiment of a cover of the present invention; and

FIG. 8 presents a perspective view of an embodiment of the present invention having an electronics package disposed in a separate housing.

Like reference numerals refer to like parts throughout the various views of the drawings.

### DETAILED DESCRIPTION OF THE INVENTION

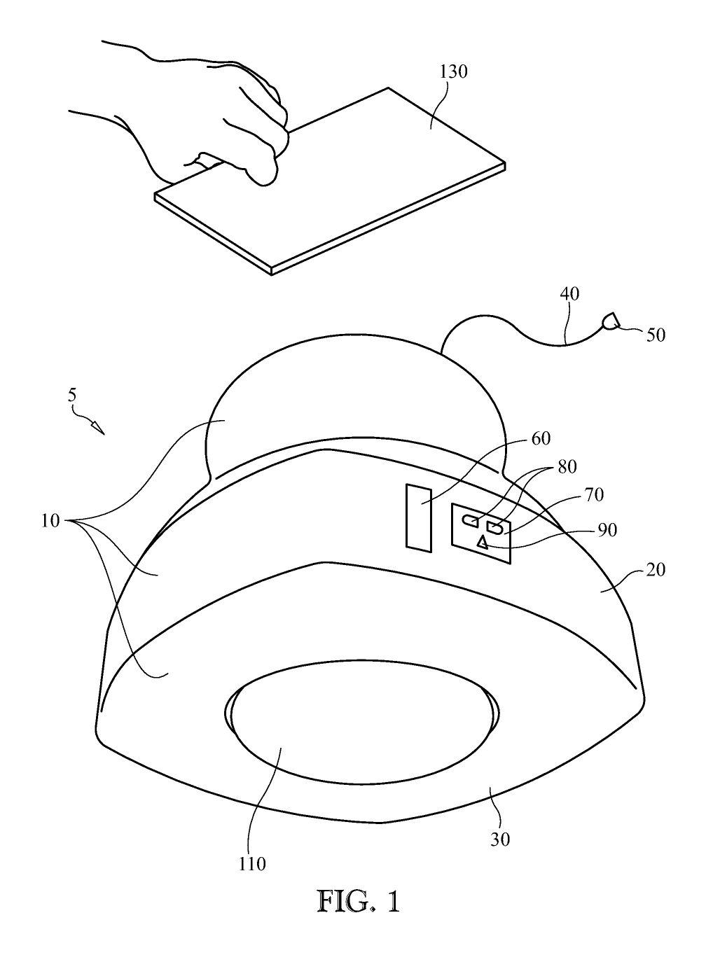

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The system, of the present invention, for administering therapeutic patterned percussive pulses and a patterned fluctuating magnetic field includes a transducer, a transponder, an electronics package, and a power supply. The transducer 5 and the transponder or passive wireless instruction device 130 are illustrated in FIG. 1. The transducer 5 includes a housing 10 comprised of a cover 20 and a contact plate 30. The housing 10 is preferably constructed of rigid and lightweight material, such as ABS plastic and it is advantageous that the contact plate 30 has a smooth polished outside surface with convex curvature. The cover 20 is a hollow body contoured to facilitate holding by hand with an entryway defining an interior space. The cover 20 is provided with a connecting interface for releasably engaging the contact plate 30 to close the entryway. The suitable connecting interface may be a conventional snap-fit lip configured to mate with the contact plate 30. The housing 10 may be manually manipulated for sliding the contact plate 30 on the skin of a subject. A power cord 40 extends from the cover 20 at a location opposite the contact plate 30 and terminates in a power connector 50 for connecting the device to a conventional power supply (not shown). An LCD display 60 and a push-button panel 70 are mounted on the cover 20. The push-button panel 70 includes two volume control buttons 80 and a play/pause button 90. The power cord 40 is operably connected to an electronics package preferably disposed inside the housing 10 for delivering therapeutic pulses and a fluctuating magnetic field, both of which are applied to the skin of a subject by a hammer pad 110.

The transducer 5 is capable of delivering a series of pulses, at a selected frequency, by a succession of percussive strikes on the skin of a subject, by the hammer pad 110, driven by the electronics package, at the selected frequency. Likewise, the hammer pad 110 causes a magnetic field to fluctuate at the selected frequency proximate to the skin of the subject. In addition, the transducer 5 is intended, not only for delivering a series of pulses and a fluctuating magnetic field, at a selected frequency but the transducer 5 is intended for selectively delivering a plurality of ailment specific patterned percussive pulses and fluctuating magnetic field, according to the ailment specific patterns developed by research. It is intended that ailment specific patterns of sound waves be prerecorded as audio programs conventionally configured for storage in computer readable format.

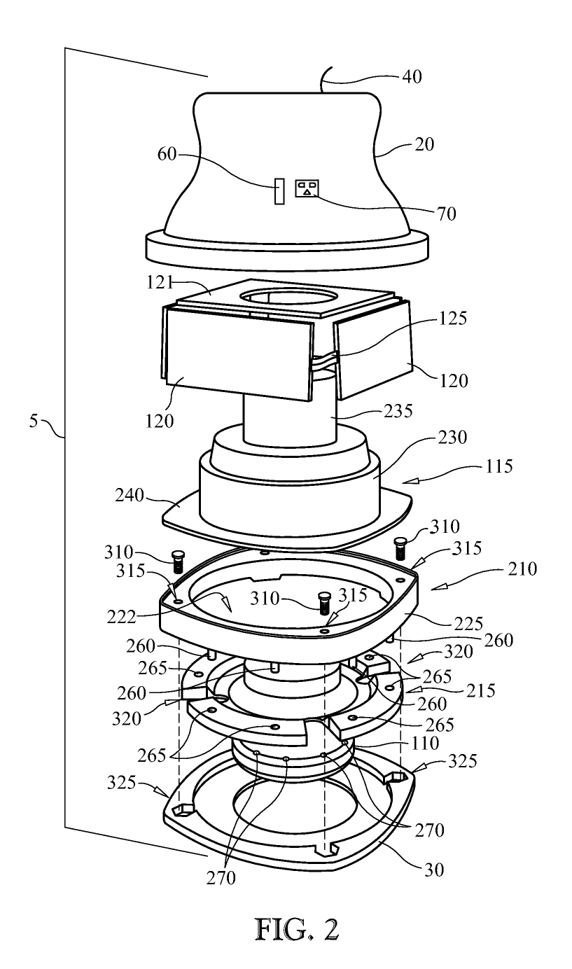

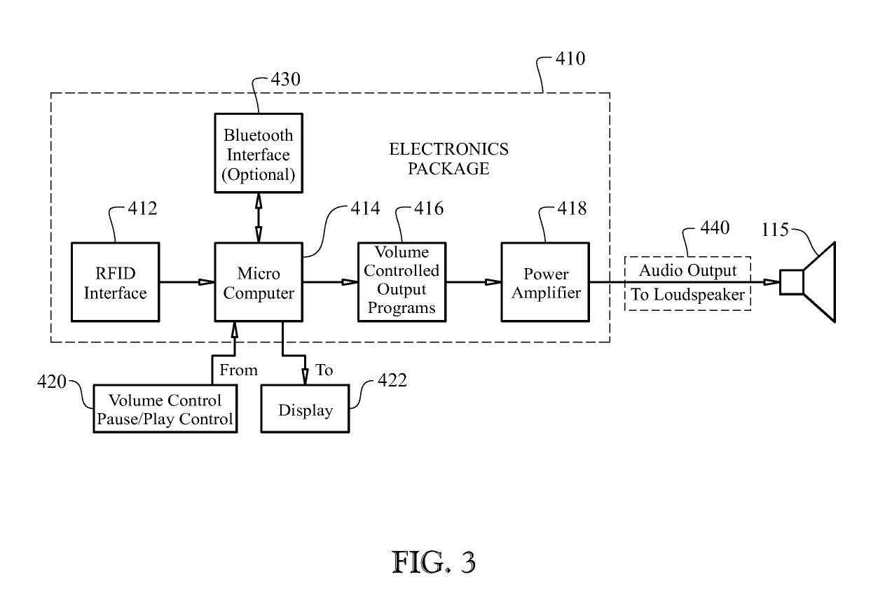

The electronic and mechanical elements of the transducer 5 are depicted in FIG. 2, which shows an exploded perspective view of an embodiment of the transducer 5. The transducer 5 includes a sound pressure wave generating device 115 (such as a loudspeaker), an electronics package 410, and a pulse delivery assembly. The electronics package 410, shown as a block diagram, in FIG. 3, is preferably disposed inside the housing 10 and formed on one or more flex-rigid circuit cards 120, 121, shown in FIG. 2, which may be conventionally interconnected by multiple wires or by flexible wire ribbon 125, as indicated in FIG. 2. The flex-rigid circuit cards 120, 121 are assembled in a conventional manner having interconnected signal transceiver 412, which is preferably a passive radio frequency transceiver similar to a radio frequency identification (RFID) interface, a microcomputer 414, a power amplifier 418 and an audio signal output 440. The flex-rigid cards 120, 121 are preferably disposed within the space proximate to the sound pressure wave generating device 115, as explained in further detail below. The power amplifier 418 may preferably include a digital to analog signal converter. The signal transceiver 412 is configured to receive and process an instruction, from the transponder, and to deliver a command signal to the microcomputer 414. The system includes a plurality of prerecorded audio programs uniquely labeled and stored therein. The system includes a digital interface and respective software for retrieving and outputting one or more of the programs identified by the labels. Each program may preferably consist of up to five tones varied and repeated to form a pattern. Patterns may include one or more periods of silence. In a first embodiment, the microcomputer 414 is programmed and configured to receive, label, store, retrieve, and output a plurality of prerecorded audio programs. The microcomputer 414 is preferably a microprocessor operably connected to a memory. In use, a plurality of ailment specific programs, each being a pattern of sequenced tones are prerecorded in digital format, uniquely labeled and stored on the microcomputer. Alternatively, each label may consist of an ordered list of pointers configured to control the microprocessor for reproducing a program by generating a particular pattern of tones of specified frequency and duration. In one embodiment, an individual suffering with a particular ailment would be provided with a passive wireless instruction device 130 having a set of pulse generating instructions 140 either embedded or programmed therein. The transponder or passive wireless instruction device 130 may preferably be a passive transmissive or RFID styled card, shown in FIG. 1. The passive wireless instruction device 130 includes one or more electronic labels which associate the specific transponder or passive wireless instruction device 130 with a respective ailment treating program or programs. Placement of the transponder or passive wireless instruction device 130 proximate to the transducer 5 activates the passive wireless interface within the passive wireless instruction device 130. The passive wireless interface emits a signal having the set of instructions 140 embedded therein. The signal transceiver 412 received and uses a microprocessor 414 or other circuit to decode the instruction set 140. It is understood that a user may manually initiate the passive wireless interface. The microprocessor 414 may optionally be configured to initially read the series or index of labels 142, enabling the user to review the options and select one or more of prerecorded instruction sets 140 identified by the labels 142. Once selected, the system The microcomputer 414 outputs one or more of the received audio programs to the power amplifier 418, through which the output 440 is delivered to drive the sound pressure wave generating device 115 (represented as a loudspeaker in block diagram format in FIG. 3) for reproducing the program as sounds.

In a second embodiment, the passive wireless instruction device 130 includes an electronic circuit 410 (FIG. 3) configured to receive, label 142, and store a plurality of prerecorded audio programs 140, formulated as a set of instructions to generate a series of percussive pulses with fluctuating magnetic fields. The passive wireless interface 412 is configured to read the instruction and issue a respective command signal to the microcomputer 414, which responds by retrieving and outputting the one or more audio programs to the power amplifier, through which the output is delivered to drive the sound pressure wave generating device 115 for reproducing the program as sounds.

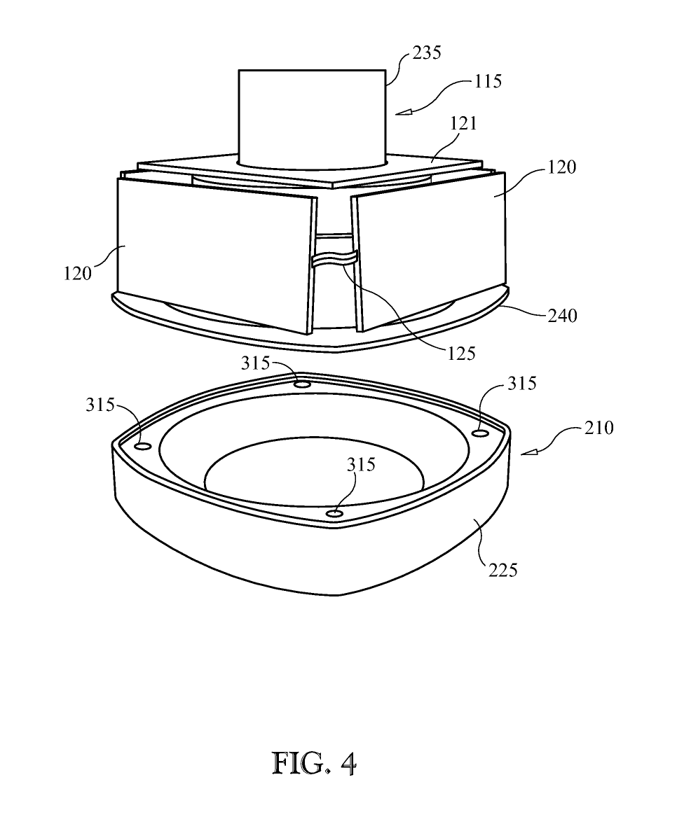

Returning to FIG. 2, the pulse delivery assembly includes a separator 210, a suspension 215, and a hammer pad 110. The separator 210 includes a rigid planar frame 225, preferably formed of ABS plastic and having a central aperture 222. The exemplary sound pressure wave generating device 115 is a loudspeaker, which includes a speaker cone 230, a speaker magnet 235, and a mounting interface. An exemplary three-inch (3″) conventional audio speaker will serve the purpose of the present invention. The mounting interface may comprise a radial flange 240 utilizing conventional fasteners (not shown), adhesive, and the like for securing the sound pressure wave generating device 115 to the separator 210 or other feature within the transducer 5. In the exemplary embodiment, the sound pressure wave generating device 115 is attached to the separator 210 by the fasteners. The sound pressure wave generating device 115 is generally aligned with the central aperture 222 and the flange 240 is oriented having an adjacent co-planer relation with the frame 225, as illustrated in FIG. 4. The flex-rigid circuit cards 120 are preferably disposed in the space surrounding the sound pressure wave generating device 115. The modified flex-rigid circuit card 121, which is located at a rear edge and generally perpendicular to a central axis of the sound pressure wave generating device 115, further comprises a void for receiving the speaker magnet 235, thus providing a more compact arrangement, as illustrated in FIGS. 2 and 4.

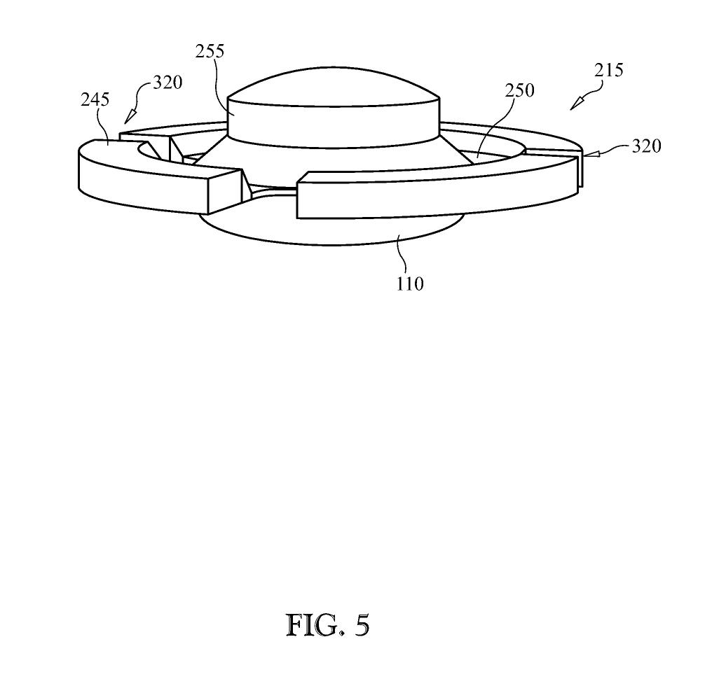

The suspension 215, shown in FIG. 5, comprises a perimeter rim 245, a flexible and resilient membrane 250, and a central projection 255, The suspension 215 is preferably formed as a unitary construct and fabricated of any pliant material, such as silicone rubber, nylon, and the like. It is understood that the suspension 215 may be fabricated of one or more materials. The rim 245 is aligned with and disposed adjacent to the frame 225 on a side opposite the sound pressure wave generating device 115. The rim is preferably located and retained by inserting a plurality of studs 260 extending from the frame 225 through corresponding holes 265 provided on the rim 245. The suspension 215 is located such that the membrane 250 overlays the central aperture 222 and the central projection 255 extend through the central aperture 222. The hammer pad 110 is attached to the membrane 250 opposite the central projection 255. It is preferred that the suspension 215 be formed by injection molding and that the hammer pad 110 be formed of ABS plastic. In order to adequately secure the hammer pad 110 to the membrane 250, it is preferred that the hammer pad 110 be formed comprising a plurality of anchors (not shown) and that the hammer pad 110 be pressed onto the molded suspension 215 during the curing process and with the anchors embedded in the silicone rubber of the suspension 215. As the curing process completes, a firm bond is established between the hammer pad 110 and the membrane 250. It is also preferred that a plurality of permanent magnets 270 be attached to the surface of the hammer pad 110, preferably by molding or use of an adhesive.

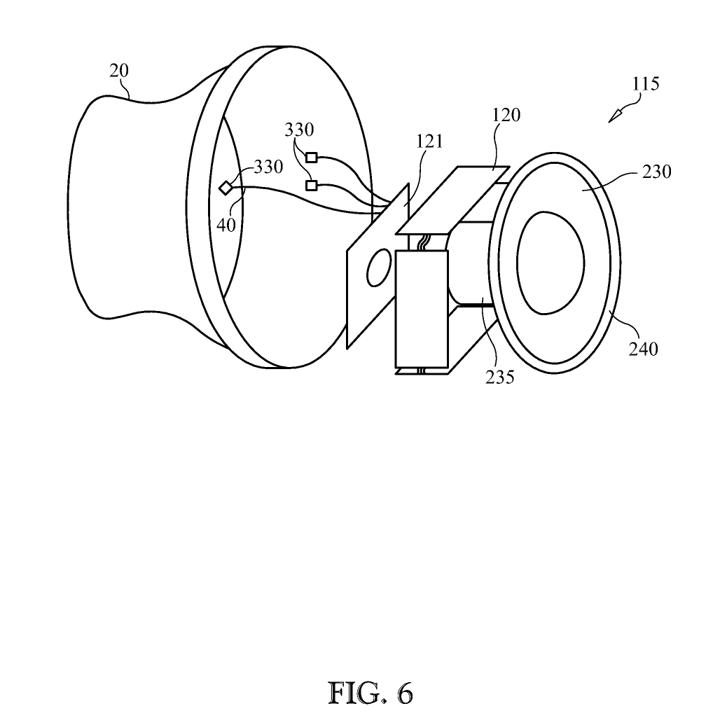

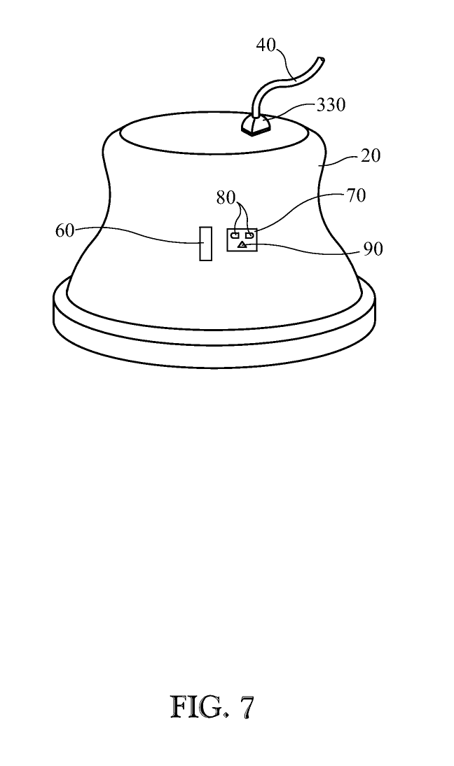

The pulse delivery assembly includes the hammer pad 110, the suspension 215, and the separator 210. The sound pressure wave generating device 115 attached is attached to the pulse delivery assembly and the complete assembly is affixed to the inside surface of the contact plate 30, by any attachment interface or fastener, such as a plurality of bolts 310 which are inserted along the path indicated by dotted lines, in FIG. 2. The bolts 310 are inserted through aligned bores 315 provided in the frame 225 of the separator 210, passing through notches 320 provided in the rim 245 of the suspension 215, and continuing through nut retainers 325 provided on the inside surface of the contact plate 30. Nuts (not shown) are permanently fixed in the nut retainers 325, for receiving and retaining the bolts 310 to fixedly retain the pulse deliver assembly with the hammer pad 110 at least partially protruding through the central opening. It will be appreciated by those skilled in the art that other conventional attachment interfaces are suitable. When assembled, the central projection 255 rests in contact with the speaker cone 230 providing an interface for transferring vibration of the speaker cone 230 to the hammer pad 110. Adjacent portions of the central projection 255 and the speaker cone 230 may be cooperatively contoured to distribute forces of percussion. The electronics package 410, together with the sound pressure wave generating device 115 fastened to the pulse delivery assembly, are disposed inside the cover 20, as illustrated in FIG. 6. Conventional portal fittings 330 are provided for operably connecting the power cord 40 to the electronics assembly and for operably connecting the electronics assembly to the LCD display 60 and the push button panel 70, which are mounted on the cover 20, as shown in FIG. 7, for convenient access. A strain relief plug or similar feature may be employed for supporting any or all cording or wiring, such as the power cord 40. The audio output from the amplifier is connected to the sound pressure wave generating device 115 by signal wires (not shown).

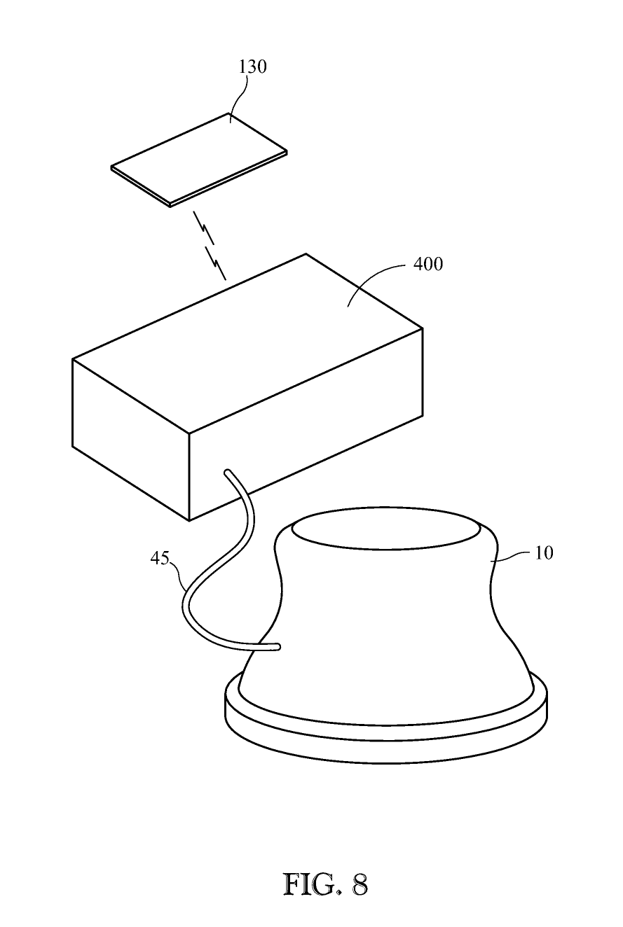

Alternatively, it may be desirable to design the system with the electronics package 410 outboard of the housing, shown in FIG. 8, in which case, the electronics package 410 would be disposed in an electronics housing 400 with an LCD display 450 and push button panel 460 located on the electronics housing 400. In this embodiment, the power cord 40 would connect through the electronics housing 400, to the electronics package and an audio output wire 45 would connect from the electronics housing 400 to the sound pressure wave generating device 115 inside the housing 10.

In use, a passive wireless instruction device 130 includes an electronic data storage device 132 in signal communication with a passive antenna 134, which stores one or more electronic instruction programs 140, wherein each program 140 is directed towards treatment of one or more specific ailments. Each electronic instruction file 140 includes a specific program label 142 for reference. The program, user or other can select one, several or all of the electronic instruction files 140 to be transferred.

The passive wireless instruction device 130 is positioned to a location proximate to the electronics package 410 causing the microcomputer to copy one or more electronic instruction programs 140 from the passive wireless instruction device 130. The electronics package 410 utilizes information within the program(s) 140 by driving the sound pressure wave generating device 115 accordingly. The speaker cone 230 translates vibrations to the membrane 250, by striking, causing the synchronized vibration of the hammer pad 110. While the programs 140 are being processed, the outside surface of the contact plate 30 may be slidably moved in contact with the skin of a subject allowing the hammer pad 110 to deliver patterned percussive pulses by striking the skin. Simultaneously, the magnets 270 are carried in vibrating motion, with the hammer pad 110 to administer a patterned fluctuating magnetic field to the skin proximate to or contacting the device. The percussive strikes and the fluctuating magnetic field are governed by the sound tone pattern of the prerecorded programs 140. The electronic instruction programs 140 are stored within the electronic data storage device 132 of the passive wireless instruction device 130. The passive wireless instruction device 130 is of a size and shape enabling an individual or physician to easily carry and transport the passive wireless instruction device 130. This enables simple on site treatment of one or more one or more specific ailments using an appropriate ailment specific audio program 140 or series of programs 140. Positioning the passive wireless instruction device 130 proximate to the electronics package 410 may automatically cause the system to administer patterned therapeutic pulses and fluctuating magnetic field specific to the diagnosed ailments of the individual.

It is also understood that the magnets 270 may be electromagnets driven by electrical pulses.

It is preferred that the microcomputer 414 be programmed and configured, in a conventional manner, to receive push button control input, for requesting and receiving one or more electronic instruction programs, for starting and stopping operation, for controlling audio output volume, and for outputting a display identifying the program 140 being reproduced. It is also preferred that the microcomputer 414 be operably connected, in conventional manner, with the play/pause button 90, the volume control buttons 80, and the LCD display 60. While the device is active, a user may operate the play/pause button 90 to control the operation by stopping and restarting the device by repeatedly pressing the play/pause button 90. Likewise, the user may operate the volume buttons 80 to increase or decrease the intensity of the vibrations being delivered by the transducer 5. The user may view the LCD display 60 to identify the program 140 being delivered by the transducer 5.

In an alternative embodiment, the signal transceiver 412 may be a personal area network interface, configured for recognizing the proximate presence of a network enabled input device having electronic instruction programs 140 for reproducing one or more labeled ailment specific prerecorded programs 140 and for automatically establishing a communication protocol. It is intended that a Bluetooth® system 430, conventionally installed and operably connected to the microcomputer may serve as the signal transceiver, shown as an optional element of the electronics package 410 in FIG. 3, in which case, a variety of enabled input devices capable of electronically storing labels 142 identifying ailment specific prerecorded programs 140 and ailment specific prerecorded programs 140 would serve as a transponder 130. Various examples of potential conventional electronics devices which can be adapted for use as a transponder 130 include Portable Computers, Tablets, Smart Phones, MP3 players, Personal Data Assistants (PDA's), and the like may be suitable transponders 130. In addition, data intended for storage on the transponder 130 may be stored on a memory card, such as an SD card, portable hard drives, or portable USB thumb drives.

Another alternative embodiment of the system of the present invention may be provided by omitting the magnets 270 to yield a system for delivering patterned percussive pulses to the skin of a subject.

It is understood the implementation of the transponder or wireless instruction device 130 can be either passive (exclusive of any battery), active (inclusive of an on-board or connected battery or other power source that always broadcasts or beacons its signal) or battery assisted passive (BAP) which has a small battery on board that is activated when in the presence of an RFID transceiver. Passive RF technology utilizes inductive properties to excite an antenna, which in turn creates a current. The current generates the power required to operate the receiving circuit. Data carried by the signal is decoded, interpreted and acted upon accordingly.

Those skilled in the art can recognize the application of the RFID technology for use with the exemplary disclosed transducer as well as any other sound pressure wave generating device, including a loudspeaker, transducer, electro-acoustic transducer, piezoelectric transducer, and the like.

The system of the present invention is useful for treating human subjects and may also be used on mammals, particularly livestock and pets.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An ailment treatment system for administering therapeutic patterned percussive pulses to the skin of a subject, comprising:
a passive wireless instruction device, a transducer, an electronics package, and a power supply;
said passive wireless instruction device comprising an electronic data storage device and a passive transceiving antenna, said passive transceiving antenna in signal communication with said electronic data storage device;
at least one electronic instruction program stored within said electronic data storage device;
said transducer comprising a sound pressure wave generating device, a pulse delivery assembly, and a housing;
said electronics package comprising an operational circuit including a signal transceiver, a microcomputer, and an audio signal output, said operational circuit being in electrical communication with said power supply;
said signal transceiver being operably connected to said microcomputer and being configured to initiate communication with said passive wireless instruction device, receive and process at least one electronic instruction program from said electronic data storage device and to deliver a command signal to said microcomputer;
said microcomputer being programmed and configured to receive said command signal, and outputting one or more audio programs, according to the said command signal;
said operational circuit being in signal communication with said sound pressure wave generating device for inputting an audio signal thereto;
whereby said at least one electronic instruction program provides a series of instructions utilized by said microprocessor to generate a signal output, wherein said signal output causes generation of a series of patterned therapeutic percussive pulses created by said sound pressure wave generating device, said patterned therapeutic percussive pulses being directed towards the skin of an individual for administering therapy for an ailment.

2. An ailment treatment system as recited in claim 1, said signal transceiver and passive wireless instruction device further comprising circuitry providing wireless communication therebetween, said wireless communication utilizing passive wireless technology.

3. An ailment treatment system as recited in claim 2, said passive wireless instruction device further comprising an antenna for receiving a radio frequency signal, said antenna being in signal communication with said electronic data storage device for encoding said at least one electronic instruction program within a current for subsequent transmission,
wherein said signal transceiver emits said radio frequency signal, which excites said antenna.

4. An ailment treatment system as recited in claim 1, further comprising at least one label, wherein said at least one label is associated with a respective electronic instruction program of the at least one electronic instruction program.

5. An ailment treatment system as recited in claim 1, said electronics package comprising further comprising a power amplifier.

6. An ailment treatment system as recited in claim 5, the system further comprising a volume control, wherein said volume control adjusts an amplitude of the audio signal.

7. An ailment treatment system as recited in claim 5, the system further comprising a display, wherein said display provides an interface for a user of at least one of operational control of said system, selection of one of said at least one electronic instruction program and amplitude of the audio signal.

8. An ailment treatment system for administering therapeutic patterned percussive pulses to the skin of a subject, comprising:
a passive wireless instruction device, a transducer, an electronics package, and a power supply;
said passive wireless instruction device comprising an electronic data storage device and a passive transceiving antenna, said passive transceiving antenna in signal communication with said electronic data storage device;
at least one electronic instruction program stored within said electronic data storage device;
said transducer comprising a sound pressure wave generating device, a pulse delivery assembly, at least one magnet, and a housing;
said electronics package comprising an operational circuit including a signal transceiver, a microcomputer, and an audio signal output, said operational circuit being in electrical communication with said power supply;
said signal transceiver being operably connected to said microcomputer and being configured to initiate communication with said passive wireless instruction device, receive and process at least one electronic instruction program from said electronic data storage device and to deliver a command signal to said microcomputer;
said microcomputer being programmed and configured to receive said command signal, and outputting one or more audio programs, according to the said command signal;
said operational circuit being in signal communication with said sound pressure wave generating device for inputting an audio signal thereto;
whereby said at least one electronic instruction program provides a series of instructions utilized by said microprocessor to generate a signal output, wherein said signal output causes generation of a series of percussive pulses with fluctuating magnetic fields created by combination of said sound pressure wave generating device and at least one magnet, said patterned therapeutic percussive pulses with fluctuating magnetic fields being directed towards the skin of an individual for administering therapy for an ailment.

9. An ailment treatment system as recited in claim 8, said signal transceiver and passive wireless instruction device further comprising circuitry providing wireless communication therebetween, said wireless communication utilizing passive wireless technology.

10. An ailment treatment system as recited in claim 9, said passive wireless instruction device further comprising an antenna for receiving a radio frequency signal, said antenna being in signal communication with said electronic data storage device for encoding said at least one electronic instruction program within a current for subsequent transmission,
wherein said signal transceiver emits said radio frequency signal, which excites said antenna.

11. An ailment treatment system as recited in claim 8, further comprising at least one label, wherein said at least one label is associated with a respective electronic instruction program of the at least one electronic instruction program.

12. An ailment treatment system as recited in claim 8, said electronics package comprising further comprising a power amplifier.

13. An ailment treatment system as recited in claim 12, the system further comprising a volume control, wherein said volume control adjusts an amplitude of the audio signal.

14. An ailment treatment system as recited in claim 12, the system further comprising a display, wherein said display provides an interface for a user of at least one of operational control of said system, selection of one of said at least one electronic instruction program and amplitude of the audio signal.

15. An ailment treatment system for administering therapeutic patterned percussive pulses to the skin of a subject, comprising:
a wireless instruction device, a transducer, an electronics package, and a power supply;
said wireless instruction device comprising an electronic data storage device and a wireless interface;
at least one electronic instruction program stored within said electronic data storage device;
said transducer comprising a sound pressure wave generating device, a pulse delivery assembly, at least one magnet, and a housing;
said electronics package comprising an operational circuit including a signal transceiver, a microcomputer, and an audio signal output, said operational circuit being in electrical communication with said power supply;
said signal transceiver being operably connected to said microcomputer and being configured to initiate communication with said wireless instruction device, receive and process at least one electronic instruction program from said electronic data storage device and to deliver a command signal to said microcomputer;
said microcomputer being programmed and configured to receive said command signal, and outputting one or more audio programs, according to the said command signal;
said operational circuit being in signal communication with said sound pressure wave generating device for inputting an audio signal thereto;
whereby said at least one electronic instruction program provides a series of instructions utilized by said microprocessor to generate a signal output, wherein said signal output causes generation of a series of percussive pulses with fluctuating magnetic fields created by combination of said sound pressure wave generating device and at least one magnet, said patterned therapeutic percussive pulses with fluctuating magnetic fields being directed towards the skin of an individual for administering therapy for an ailment.

16. An ailment treatment system as recited in claim 15, said signal transceiver and wireless instruction device further comprising circuitry providing wireless communication therebetween, said wireless communication utilizing wireless technology.

17. An ailment treatment system as recited in claim 15, said wireless instruction device further comprising an antenna for receiving a radio frequency signal, said antenna being in signal communication with said electronic data storage device for encoding said at least one electronic instruction program within a current for subsequent transmission,
wherein said signal transceiver emits said radio frequency signal, which excites said antenna.

18. An ailment treatment system as recited in claim 15, further comprising at least one label, wherein said at least one label is associated with a respective electronic instruction program of the at least one electronic instruction program.

19. An ailment treatment system as recited in claim 15, said electronics package comprising further comprising a power amplifier.

20. An ailment treatment system as recited in claim 19, the system further comprising a volume control, wherein said volume control adjusts an amplitude of the audio signal.
